(19) United States
(12) Patent Application Publication
(10) Pub. No.: US 2012/0260869 A1
(43) Pub. Date: Oct. 18, 2012

(54) PISTON FOR AN INTERNAL COMBUSTION ENGINE, AND INTERNAL COMBUSTION ENGINE HAVING A PISTON

(76) Inventor: Marcus Freidhager, Erlangen (DE)

(21) Appl. No.: 13/499,973

(22) PCT Filed: Sep. 1, 2010
(86) PCT No.: PCT/EP2010/062799

§ 371 Date: Jun. 26, 2012

(30) Foreign Application Priority Data
Oct. 7, 2009 (DE) 102009045437.3

(51) Int. Cl. F02F 3/22; F02F 3/00

(52) U.S. Cl. 123/41.39; 123/193.6

(57) ABSTRACT

A piston for an internal combustion engine has, on the lower edge thereof opposite the piston crown, at least one cutout formed in the radial direction. An internal combustion engine is provided with at least one such piston.

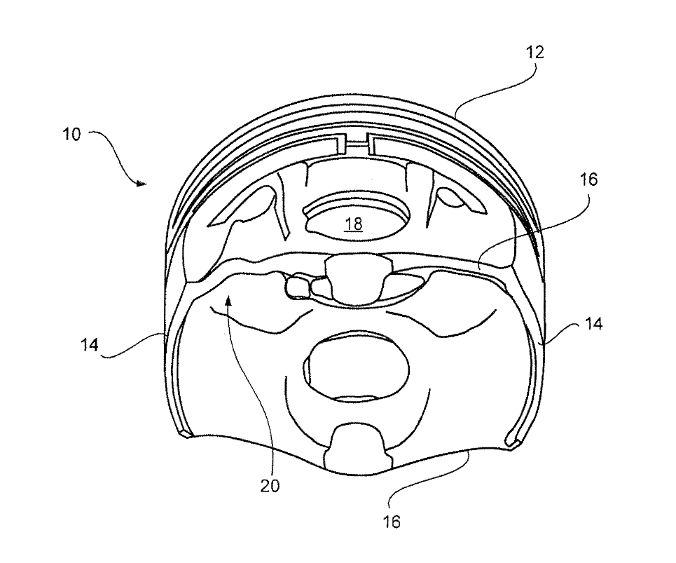

### TECHNICAL FIELD

The invention relates to a piston for an internal combustion engine and an internal combustion engine having a piston.

In the field of internal combustion engines in which pistons move in cylinders or cylinder liners and, together with other components, define the combustion chamber, under certain circumstances, it is usual to provide the piston with, for example, annular cooling channels and to inject coolant, for example, coolant oil into said channels by means of one or more nozzles. It is understood that under no circumstances should too little free space be left between the coolant oil nozzle and any parts of the piston, nor even should a collision occur between said components. It has therefore previously been necessary to adapt the piston design to any altered positions of the coolant nozzles. This can be particularly expensive because entire new casting tools have to be produced.

### PRIOR ART

WO 2006/014741 A2 discloses a piston for an internal combustion engine wherein, at the lower edge of the piston body, a notch is provided, formed in the direction of the piston axis, that is, in the axial direction. Said notch serves to accommodate a coolant oil nozzle or a feed line thereto, particularly at the bottom dead centre position of the piston.

### SUMMARY OF THE INVENTION

Against the background as set out above, it is an object of the invention to provide a piston for an internal combustion engine and an internal combustion engine equipped therewith, wherein increased flexibility is achieved with regard to different positions of coolant oil nozzles.

This aim is achieved with the piston described in claim 1.

Said piston therefore has at least one cutout formed in the radial direction at the edge which, in the position of use of said piston, is usually the lower edge, opposing the edge which delimits the combustion chamber, that is the piston crown. In other words, the “interior chamber” of the piston defined by piston body wall sections which, in use, lie against the cylinder walls and by the connecting walls provided therebetween is extended in the radial direction. This extension leads, if the piston is observed in the axial direction, at the external side of the connecting wall or walls in which the cutout is usually formed, to a convexity or bulge. This applies, in particular, if the wall thickness in the region of the cutout is substantially equal to the wall thickness adjacent thereto. Irrespective thereof, however, the cutout or niche described can be formed even if the wall thickness is lessened at the inside thereof, providing additional space for different positions of coolant oil nozzles.

This leads to an improvement compared with a situation in which, for whatever reasons, the coolant oil nozzle has been slightly offset outwardly in the radial direction, and the design of the nozzle must consequently be altered. With the piston according to the invention, the cutout or niche described enables additional coolant oil nozzle positions, so that the usability of the piston according to the invention is improved and the cost effectiveness thereof is increased. It has been found, in particular, that existing piston tools can be converted to form the cutout according to the invention without the need to use new components. A finite element analysis has also demonstrated the fundamental practicability of the piston according to the invention.

Preferred embodiments are described in the further claims.

In order not to jeopardise the stability of the piston in the lower region thereof and, at the same time, to restrict the material use advantageously, it is preferred to configure the material thickness at the section bordering the cutout to be approximately equal to the regions adjacent to the cutout.

Furthermore, notches or the like at the lower edge of the piston can advantageously be avoided in that, as is preferred, the lower edge of the piston in the region of the cutout lies approximately at the same level as adjacent thereto.

A depth in the range of one to three millimetres in the radial direction has been found to be favourable for the at least one cutout at the lower edge of the piston.

In order to take account of corresponding configurations of coolant oil nozzles and/or to ensure a harmonious transition to the region above the described cutout, it may be favourable to configure the cutout with a depth in the radial direction that lessens going away from the lower edge in the direction of the piston axis.

Initial considerations regarding the practical use of the piston according to the invention have revealed that a configuration of the described cutout on the counterpressure side of the piston is preferred.

The invention also relates to an internal combustion engine which, in addition to the above described piston, comprises at least one coolant oil nozzle. For the distance between the coolant oil nozzle and the described cutout, in order to take account of the operating conditions and particular tolerances, a value of two millimetres of more is preferred.

### BRIEF DESCRIPTION OF THE DRAWINGS

An exemplary embodiment of the invention will now be described in greater detail making reference to the drawing.

The single FIGURE shows a perspective view from below of a piston according to the invention.

### DETAILED DESCRIPTION OF A PREFERRED EMBODIMENT OF THE INVENTION

The FIGURE shows a piston 10 according to the invention seen from the underside opposing the piston crown 12. The lower edge of the piston 10 is formed here by the respective lower edges of the body wall sections 14 and the connecting walls 16 between the body wall sections 14. As the FIGURE shows, a cutout 20 is provided in the region of a connecting wall, adjacent to a piston pin bore 18. In other words, in the example shown, the connecting wall 16, with a wall thickness which remains substantially constant and/or with an edge which remains at substantially the same level in the axial direction, is slightly bulged outwardly in the radial direction, so that a cutout or niche is formed at the internal side, that is, toward the opposing connecting wall 16. A coolant oil nozzle can be accommodated in said cutout or niche, even with an altered position of said nozzle, so that the deployment possibilities of the piston according to the invention are improved in an economically favourable manner.

1. A piston for an internal combustion engine, having at least one cutout formed in the radial direction at the lower edge opposing the piston crown, said cutout extending an interior chamber of the piston defined by piston body wall sections which, in use, lie against the cylinder walls and by the connecting walls provided therebetween, in the radial direction.

2. The piston according to claim 1, wherein the material thickness at the section bordering the cutout is approximately equal to the material thickness adjacent to the cutout.

3. The piston according to claim 1, wherein the lower edge of the piston in the region of the cutout lies approximately at the same level as adjacent to said cutout.

4. The piston according to the cutout at the lower edge of the piston has a depth in the range of approximately 1 mm to 3 mm in the radial direction.

5. The piston according to claim 1, wherein the depth of the cutout lessens, going away from the lower edge of the piston, in the direction of the piston axis.

6. The piston according to claim 1, wherein the at least one cutout is formed on the counterpressure side of the piston.

7. An internal combustion engine having at least one piston according to at least one of the preceding claims and at least one coolant oil nozzle, wherein a distance between the coolant oil nozzle and the border of the cutout is preferably approximately 2 mm or more.
